(19) United States
(12) Patent Application Publication
(10) Pub. No.: US 2018/0205749 A1
(43) Pub. Date: Jul. 19, 2018

(54) Detecting A Rogue Access Point Using Network-Independent Machine Learning Models

(71) Applicant: QUALCOMM Incorporated, San Diego, CA (US)

(72) Inventors: Sriram Nandha Premnath, San Jose, CA (US); Seyed Ali Ahmadzadeh, San Jose, CA (US); Saumitra Mohan Das, San Jose, CA (US)

(21) Appl. No.: 15/408,629

(22) Filed: Jan. 18, 2017

(51) Int. Cl. H04L 29/06; G06N 99/00

(52) U.S. Cl. CPC H04L 63/1416; H04W 76/02; G06N 99/005; H04L 63/10

(57) ABSTRACT

Embodiments include systems and methods of detecting a rogue access point by a computing device. A processor of the computing device may determine one or more features of a purported access point. The processor may calculate delta features of the purported access point based on the determined one or more features and an access point profile. The processor may apply the calculated delta features to a machine-learning model. The processor may generate an access point classification based on the application of the calculated delta features to the machine-learning model. The processor may prevent the computing device from associating with the purported access point in response to determining that the purported access point is a rogue access point, and permit associating with the access point otherwise.

### BACKGROUND

A “rogue access point” is a device that impersonates a legitimate wireless network access point. A wireless communication device that connects to a rogue access point may be vulnerable to attack or compromise by malicious software (“malware”) as well as eavesdropping on communications.

Using a machine-learning approach to detecting a rogue access point, while potentially very accurate, poses a variety of challenges. For example, many machine-learning approaches to malware detection use Boolean features; however, Boolean features are inadequate to detect rogue access points. While certain characteristics of access points (such as round-trip time, clock skew, and vendor-specific information) are useful for identifying different devices, networks, or specific deployments that are already present in training data, use of such features is not scalable to a larger number of networks or potential types of access points.

### SUMMARY

Various embodiments include methods and computing devices implementing methods for detecting a rogue access point by a computing device. Various embodiments may include determining, by a processor of the computing device, one or more features of a purported access point, calculating, by the processor, delta features of the purported access point based on the determined one or more features and an access point profile, applying, by the processor, the calculated delta features to a machine-learning model, and generating, by the processor, an access point classification based on the application of the calculated delta features to the machine-learning model. In some embodiments, determining one or more features of the purported access point may include determining, by the processor, one or more parameters of the purported access point, and determining, by the processor, the one or more features of the purported access point based on the one or more parameters of the purported access point. In some embodiments, determining one or more features of the purported access point may include determining, by the processor, one or more feature vectors of the purported access point.

In some embodiments, the calculated delta features may include differences between the determined one or more features and the access point profile. In some embodiments, the access point profile may include expected features of the purported access point. In some embodiments, the features of the purported access point may include observed characteristics of the purported access point.

Some embodiments may further include determining, by the processor, whether the purported access point is a legitimate access point or a rogue access point based on the generated access point classification. Some embodiments may further include preventing the computing device from associating with the purported access point in response to determining that the purported access point is a rogue access point. Some embodiments may further include permitting the computing device to associate with the purported access point in response to determining that the purported access point is a legitimate access point.

Various embodiments may further include a computing device having a signal transceiver and processor coupled to the signal transceiver and configured with processor executable instructions to perform operations of the methods summarized above. Various embodiments include a computing device having means for performing functions of the methods summarized above. Various embodiments include a non-transitory processor-readable storage medium having stored thereon processor-executable instructions configured to cause a processor of a computing device to perform operations of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIG. 1 is a component block diagram of a communication system suitable for use with various embodiments.

FIG. 2 is a block diagram illustrating logical components and information flows in an access point characterization system according to various embodiments.

FIG. 3 is a profile table according to various embodiments.

FIG. 4 is a process flow diagram illustrating a method of detecting a rogue access point according to various embodiments.

FIG. 5 is a component block diagram of a mobile communication device according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and embodiments are for illustrative purposes, and are not intended to limit the scope of the various embodiments or the claims.

Various embodiments include methods, and computing devices configured to implement the methods, for a computing device to detect rogue access points. In various embodiments, a processor of the computing device may employ a machine-learning model to determine whether a purported access point is a rogue access point.

The term “purported access point” is used herein to refer to a wireless device that transmits information received by the computing device indicating that the wireless device is an access point to a network.

The term “rogue access point” is used herein to refer to a wireless device that purports to be a benign (e.g., legitimate) access point of a communication network, but in fact is a device used by a bad actor or attacker that makes use of a wireless communication link established with a computing device to perform a malicious act on or using the computing device. For example, an attacker may place a rogue access point inside or near a company network to attempt to perform a man-in-the-middle attack to steal confidential information, or to modify messages in transit. As another example, an attacker may place a rogue access point at or near a public location where members of the public may expect an open access point, such as at an airport, or a coffee shop.

The terms “computing device” and “mobile communication device” are used interchangeably herein to refer to any one or all of laptop computers, tablet computers, cellular telephones, smartphones, personal or mobile multi-media players, personal data assistants (PDAs), smartbooks, palmtop computers, wireless electronic mail receivers, multimedia Internet enabled cellular telephones, wireless gaming controllers, drones, vehicles, and similar electronic devices which include a programmable processor and a memory. Various embodiments may be particularly useful in mobile computing and mobile communication devices, such as smart phones, tablet computers and other portable computing platforms that are easily transported to locations where rogue access points may lurk.

The terms “component,” “module,” “system,” and the like as used herein are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

Detection of rogue access points differs in many respects from the detection of malware running on a computing device. Because malware operates within the computing environment of the computing device (e.g., a wireless communication device or “smartphone”), the type and number of characteristics of the computing device that may be manipulated or used by the malware may be known in advance. Further, typical machine learning techniques for malware detection tend to use Boolean features because of the number and type of computing device characteristics. However, detection of rogue access points requires analysis of characteristics that may vary, at a minimum, from access point to access point and/or from network to network. While certain characteristics of access points (such as round-trip time, clock skew, and vendor-specific information) are useful for identifying different devices, networks, or specific deployments that are already present in training data, use of such features is not scalable to a larger number of networks or potential access points. Thus, machine-learning techniques that may successfully detect malware running on a computing device may be inadequate to detect rogue access points.

Various embodiments include machine-learning methods for detecting a rogue access point that are suitable for implementation in mobile computing devices, such as mobile communication devices. In various embodiments, a processor of a mobile communication device may apply a machine-learning model in the detection of a rogue access point. In some embodiments the machine learning model may be a single machine learning model. The rogue access point detection system, encompassing a machine-learning model, may cover or scale to a large number of networks. The machine-learning model may dynamically adjust to different deployments of the same network. Further, the machine-learning model may remain independent of any particular/specific network. Thus, various embodiments enable detection of a rogue access point that is scalable, dynamic, and network-independent.

In various embodiments, the network-independent machine-learning model may be trained on a vast number of samples of access point behavior to determine the observations that indicate a benign observation (for example, that may be consistent with a legitimate access point) and the observations that indicate a malicious observation (i.e., consistent with a rogue access point). A computing device may be configured with the network-independent machine-learning model (e.g., by download or installation).

In various embodiments, before the computing device establishes a communication link with the purported access point (e.g., by associating with the access point), the computing device may determine one or more parameters of the purported access point. The parameters of the purported access point may include one or more characteristics and/or one or more behaviors of the type of the purported access point.

In some embodiments, the processor of the computing device may determine one or more feature vectors of the purported access point based on the determined parameter(s). In some embodiments, based on the determined parameters of the purported access point, the processor may obtain an access point profile that includes one or more expected characteristics and/or behaviors of the purported access point. In some embodiments, the expected parameters may be based on one or more implementations of the determined parameters, such as a network type, a service set identifier (SSID), a base station identifier (BSID), or another implementation of the determined parameters.

The processor of the computing device may determine one or more differences or variances between the determined parameters and the expected parameters of the purported access point. For ease of reference, the differences or variances between observed and expected parameters of the purported access point are referred to herein as “delta features.” In various embodiments, determining or calculating the delta features may enable the processor of the computing device to mitigate or reduce a variation in the observed parameters (e.g., the determined parameters) of the purported access point that may occur, for example, because of specific conditions of a particular access point deployment (e.g., characteristics of a particular network, characteristics of the particular hardware of the access point, and the like).

In various embodiments, the processor of the computing device may analyze the calculated delta features. In some embodiments, the processor of the computing device may apply the calculated delta features to a single machine-learning model. Based on the analysis of the delta feature vectors, the processor may determine whether the purported access point is a benign access point or a rogue access point. In some embodiments, the processor may prevent the computing device from associating with the purported access point in response to determining that the access point is a rogue access point. In some embodiments, the processor may permit the computing device to associate with the purported access point in response to determining that the purported access point is a benign access point.

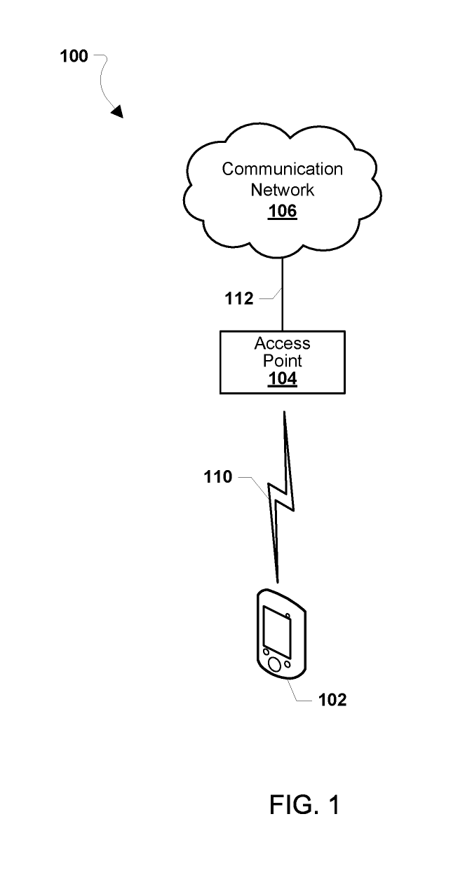

Various embodiments may be implemented within a variety of communication systems 100, an example of which is illustrated in FIG. 1. The communication system 100 may include a communication network 106, an access point 104, and a computing device in the form of a mobile communication device 102.

The access point 104 may communicate with the communication network 106 over a wired or wireless communication link 112, which may include twisted-pair backhaul links, fiber optic backhaul links, microwave backhaul links, cellular data networks, and other suitable communication links. In some embodiments, the access point 104 may include a first access point and a second access point (and/or additional access points). For example, a first access point may communicate with the communication network 106, and a second access point may communicate with the first access point via a wired or wireless communication link. The second access point may also communicate with one or more wireless stations or computing devices (e.g., the mobile communication device 102), and thus the second access point may act as a range extender in communication with the first access point. In such embodiments, the first access point may also communicate with one or more wireless communication devices.

The mobile communication device 102 may detect and attempt to associate with the access point 104 over a communication link 110. While the communication link 110 is illustrated as a single link, the communication link 110 may include a plurality of carrier signals, frequencies, or frequency bands, each of which may include a plurality of logical channels. Additionally, the communication link 110 may utilize more than one radio access technology (RAT). In some embodiments, the communication link 110 may use a relatively short-range wireless communication protocol, such as Wi-Fi, ZigBee, Bluetooth, and others. The communication link 110 may include cellular communication links using 3GPP Long Term Evolution (LTE), Global System for Mobility (GSM), Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies. Additionally, the communication link 110 may utilize more than one radio access technology.

In various embodiments, the access point 104 may be a purported access point detected by the mobile communication device 102. For example, the mobile communication device 102 may detect a signal transmitted by the access point 104, and the mobile communication device 102 may determine whether the access point 104 is a benign access point or a rogue access point.

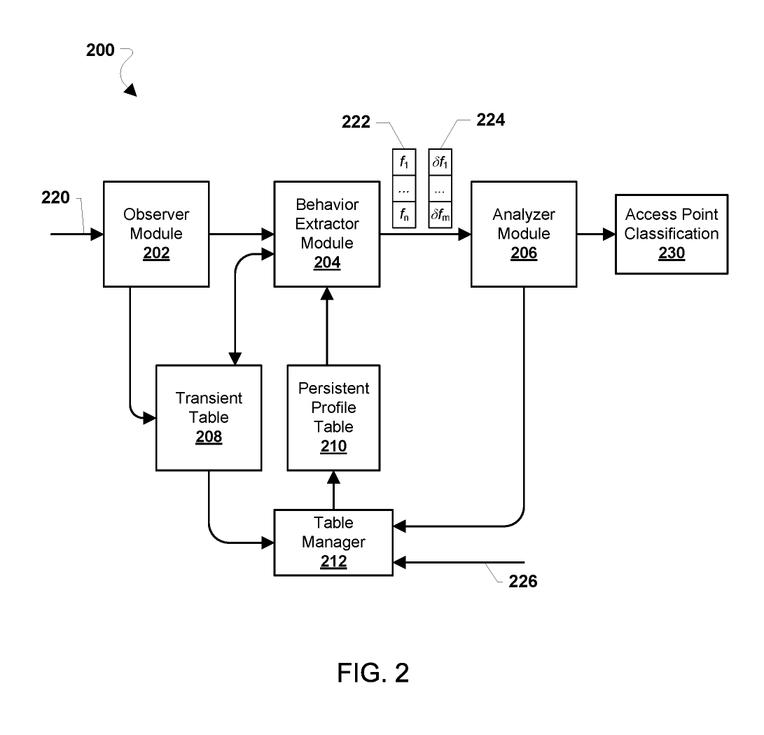

FIG. 2 illustrates example logical components and information flows in an access point characterization system 200 according to various embodiments. With reference to FIGS. 1-2, the access point characterization system 200 may be implemented in one or more processors of a computing device, such as the mobile communication device 102 (e.g., a “processor” or “device processor”). The access point characterization system 200 may include an observer module 202, a behavior extractor module 204, an analyzer module 206, and a table manager 212 executing in the one or more processors of the computing device (e.g., 102).

The behavior observer module 202 may determine parameters of a purported access point (e.g., 104) based on a variety of information 220 from the purported access point. In some embodiments, the information 220 may include a signal frequency, SSID, BSID, a round-trip time, local clock, remote clock, sequence number of frames, association status, beacon interval, signal strength, information elements (IEs), and/or other information. In some embodiments, the information 220 may include information about the communication network to which the purported access point connects. For example, the information about the communication network may include a current network load, network configuration information, whether the network is secure or open, additional network vendor-specific parameters, and/or other information.

In some embodiments, the observer module 202 may receive the information 220 passively, for example, by receiving information transmitted by the purported access point, such as beacon frames. In some embodiments, the computing device may actively send a query to the purported access point. Such a query may be initiated by the observer module 202, or another module within the one or more processors of the computing device. The observer module 202 may then receive a response to the query from which the information 220 about the purported access point may be obtained. For example, the observer module 202 may determine a round-trip time (RTT) of the query to and corresponding response from the purported access point.

In some embodiments, the observer module 202 may determine one or more parameters of the purported access point based on the information 220. The observer module 200 may pass the determined parameters to the behavior extractor module 204. The observer module 202 may also store the determined parameters in a transient table 208 or pass the determined parameters in the table manager 212, which may store the parameters of the purported access point in the persistent profile table 210. In some embodiments, the table manager 212 or the transient table 208 may perform one or more operations on the parameters of the purported access point to further refine the information. Such operations may include, for example, averaging, bit masking, verifying set membership operations, determining a Hamming distance, and/or other operations. In some embodiments, the transient table 208 may provide the determined parameters and/or the refined parameters to the table manager 212.

The behavior extractor module 204 may use the determined parameters to determine one or more features 222 of the purported access point. In some embodiments, the determined features 222 may include one or more feature vectors that describe the observed characteristics of the purported access point.

In some embodiments, the behavior extractor module 204 may also receive information from the transient table 208. For example, the behavior extractor module 204 may receive information from the transient table 208 about the type of the purported access point, a communication network of the purported access point, a manufacturer of the purported access point, or other similar information.

A feature vector may be a data structure or an information structure that includes or encapsulates one or more observed characteristics and/or behaviors of a purported access point. In some embodiments, a feature vector may include an abstract number or symbol that represents all or a portion of an observed access point behavior or characteristic (i.e., a feature). In some embodiments, each feature may be associated with a data type that identifies a range of possible values, operations that may be performed on those values, the meanings of the values, and/or other similar information. In some embodiments, the data type may be used by the access point characterization system 200 to determine how the corresponding feature (or feature value) should be measured, analyzed, weighted, or used. In some embodiments, the behavior extractor module 204 may be configured to generate a feature vector of size “n” that maps the observed information of the purported access point into an n-dimensional space or vector. Each number or symbol in the feature vector (i.e., each of the “n” values stored by the vector) may represent the value of a feature.

The behavior extractor module 204 may receive information from the persistent profile table 210. In some embodiments, the persistent profile table 210 may be populated with expected characteristics of a network and/or access points. In some embodiments, the processor of the computing device may populate the persistent profile table 210 with information based on observations of one or more legitimate access points. In some embodiments, the processor of the computing device may populate the persistent profile table 210 with information that is downloaded from, or provided by, the network element of the communication system, such as a server or another similar device.

Using the determined features 222, the information from the transient table 208, and/or the information from the persistent profile table 210, the behavior extractor module 204 may determine or calculate one or more delta features 224. Again, the calculated delta features 224 may represent differences between the determined features 222 of the purported access point and expected access point/network characteristics obtained from the persistent profile table 210. The behavior extractor module 204 may provide the calculated delta features 224 to the analyzer module 206. In some embodiments, the number of the determined features 222 in the vector of features (n) and the number of delta features 224 in the vector of delta features (m) may be different.

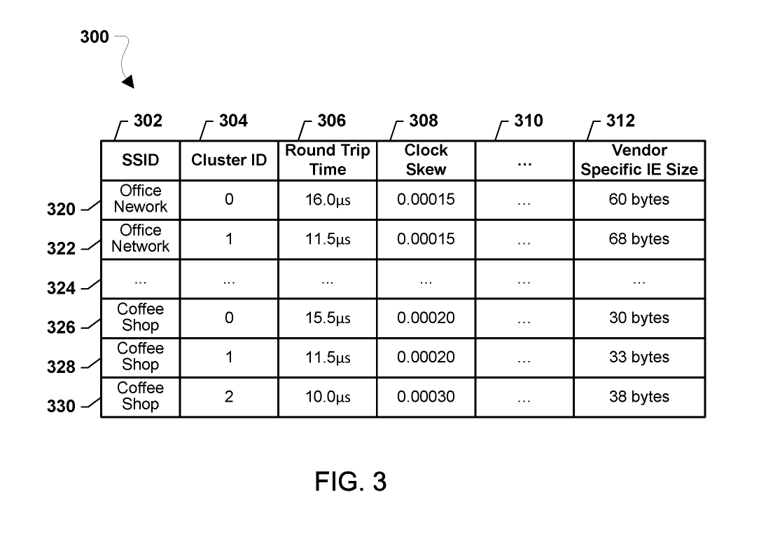

FIG. 3 illustrates an example persistent profile table 300 according to various embodiments. With reference to FIGS. 1-3, the persistent profile table 300 (which may correspond to the persistent profile table 210) may include a variety of expected characteristics of a network and/or access point. For example, the persistent profile table 300 may include an SSID 302, a Cluster ID 304, a round-trip time 306, clock skew 308, a variety of additional information 310, and a vendor specific information element (IE) size 312.

In some embodiments, the Cluster ID 304 may represent a specific observed deployment of an access point associated with a particular communication network. For example, the persistent profile table 300 includes multiple entries for specific deployments 320 and 322 (which may include variations in specific hardware and/or software used in the deployed access point) associated with a communication network associated with an office network, and which have been assigned the Cluster ID “0” and “1,” respectively. As another example, the persistent profile table 300 includes three entries 326, 328, and 330, for three observed deployment of a communication network associated with a coffee shop chain, which have been assigned the Cluster ID “0,” “1,” and “2,” respectively. The persistent profile table 300 may also include other entries 324 for other network and/or Cluster IDs, without limitation. Each of the characteristics 302-312 may represent expected characteristics of a network and/or access point.

The analyzer module 206 may use a machine-learning model to analyze the calculated delta features 224. In some embodiments, the analyzer module 206 may rapidly analyze the calculated delta features 224 to determine whether the purported access point is a legitimate access point or a rogue access point. Based on the analysis of the calculated delta features 224, the analyzer module 206 may output an access point classification 230. In some embodiments, the analysis performed by the analyzer module 206 may include applying the calculated delta features 224 to a machine-learning model. In such embodiments, based on the analysis of the calculated delta features 224 using the machine-learning model, the analyzer module 206 may output the access point classification 230. In various embodiments, the access point classification 230 may include a determination of whether the purported access point is a rogue access point or a legitimate access point.

The analyzer module 206 may also provide the access point classification 230 and the determined features 222 to the table manager 212. The table manager 212 may update the persistent profile table 210 using the determined parameters and/or the refined parameters from the transient table 208, the determined features 222, and the calculated delta features 224. In some embodiments, the table manager 212 may update the persistent profile table 210 in response to a message 226, such as a message that may be sent by the processor of the computing device in response to receiving at the processor a command to associate the computing device with the purported access point.

The analyzer module 206 may analyze the calculated delta features 224 by applying the calculated delta features 224 to a machine-learning model to evaluate the behavior of the access point. In some embodiments, the analyzer module 206 may also combine or aggregate the behavior scores of all observed behavior and/or characteristics of the purported access point, for example, into an average behavior score, a weighted average behavior score, or another aggregation. In some embodiments, the analyzer module 206 may select one or more weights based on a feature of observed behavior and/or characteristic.

In some embodiments, the machine-learning model may include information such as a weight of each input feature that the analyzer module 206 may use to evaluate a specific feature or aspect of the observed features of the purported access point. Each classifier model may also include decision criteria for monitoring a number of features of the purported access point.

In some embodiments, the characteristics of networks and/or access points stored in the persistent profile table 210 may include one or more values that represent characteristics and/or behaviors of a legitimate access point corresponding to a particular access point type and/or communication network type. In some embodiments, the processor of the computing device may update the characteristics of networks and/or access points stored in the persistent profile table 210. Such updates may converge the one or more values of each characteristic based on the observed characteristics and/or behaviors of the purported access point. Thus, the processor may change the values stored in the persistent profile table 210 based on actual observations of access points by the computing device. The values stored in the persistent profile table 210 are used by the behavior extractor module 204 to calculate a set of behaviors (e.g., the delta features 224) of a purported access point. Thus, by updating the values stored in the persistent profile table 210 based on on-device observations, the device processor may dynamically extend the coverage of the machine-learning model without changing the machine-learning model itself, and without retraining the machine-learning model. The access point characterization system 200 is therefore scalable and network-independent, and may be used to analyze the behavior of any purported access point. Thus, the access point characterization system 200 may be used to determine whether any purported access point is a legitimate or rogue access point.

In various embodiments, by calculating the delta features 224, the access point characterization system 200 may modify the observed behaviors and/or characteristics of the purported access point (e.g., the determined features 222) to capture the differences between observed values and expectations for an identified type of communication network and/or access point.

For example, in operation, the computing device may observe a previously undetected purported access point. The computing device may receive a variety of information (e.g., the information 220) from the purported access point, such as a signal frequency, SSID, BSID, a round-trip time, local clock, remote clock, sequence number of frames, association status, beacon interval, signal strength, information elements (IEs), and/or other information. The information 220 may also include information about the communication network to which the purported access point connects. For example, the information about the communication network may include a current network load, network configuration information, whether the network is secure or open, additional network vendor-specific parameters, and/or other information. In some embodiments, based on the identified network of the purported access point (e.g., the SSID 302), the behavior extractor module 204 may identify expected characteristics of the purported access point. The expected characteristics of the purported access point may include a range of expected values, or an expected range of variation of the expected characteristics.

The behavior extractor module 204 may determine delta features (e.g., the delta features 224) that represent various differences between the observed information from the purported access point and the expected characteristics of the purported access point. In some embodiments, the behavior extractor module 204 may generate the delta vectors by performing operations such as one or more of subtraction of the observed characteristic or behavior from the expected characteristic or behavior, a bit mask operation, a verification of set membership operation, determination of a Hamming distance between the expected feature and the observed feature, or another operation. Thus, by calculating the delta features, the behavior extractor module 204 may remove or reduce variations in the observed characteristics and/or behavior of the purported access point from the expected characteristics and/or behaviors of the purported access point.

The behavior extractor module 204 may pass the delta features 224 to the analyzer module 206. The analyzer module 206 may apply the delta features 224 to the machine-learning model in order to determine whether the purported access point is a legitimate access point or a rogue access point. For example, deployment 320 in the office network may have an expected round-trip time of 16.0 μs. The observer module 202 may also receive a round-trip time from a newly-observed (purported) access point of 16.1 μs. As one example, the behavior extractor module 204 may subtract the expected round-trip time 16.0 μs from the observed round-trip time 16.1 μs to determine a delta feature of 0.1 μs. The analyzer module 206 may apply the delta features 0.1 μs to the machine-learning model, and may determine that the delta feature is sufficiently close to a previously observed value that the purported access point is a legitimate access point.

As another example, the computing device may detect a purported access point that broadcasts information claiming that the purported access point is part of the “Coffee Shop” network. Using round-trip time as an example, the observer module 202 may determine a round-trip time of 20 μs for packets sent from the computing device to the purported access point. The behavior extractor module 204, using even the closest expected round-trip time value of 15.5 μs, may generate a delta value of 4.5 μs. The analyzer module 206 may apply the delta feature 4.5 μs to the machine-learning model, and may determine that the delta feature is insufficiently close to a previously observed value (e.g., not within some threshold value or percentage). The analyzer module 206 may therefore determine that the purported access point is a rogue access point. In some embodiments, the analyzer module 206 may determine whether one or more delta values exceed a variation threshold (e.g., a value or a percentage). In response to determining that the one or more delta values exceed the variation threshold, the analyzer module 206 may determine that the purported access point is a rogue access point. In response to determining that the one or more delta values do not exceed the variation threshold, the analyzer module 206 may determine that the purported access point is a legitimate access point.

While the examples above describe operations of the access point characterization system 200 using a single feature (round-trip time), in various embodiments the access point characterization system 200 may use any number of features (e.g., tens of features, or hundreds of features). Further, when applying the delta features 224 to the machine-learning model, in some embodiments, the analyzer module 206 may determine a pattern of whether various delta values are within or exceed acceptable respective threshold. In such embodiments, the analyzer module 206 may generate the access point classification 230 based on the determined pattern of whether the various delta values are within or exceed respective thresholds.

In various embodiments, the machine-learning model may be trained using a wide range of data to enable the machine-learning model to learn over time delta values of various characteristics that are associated with a rogue access point, and delta values of various characteristics that are associated with a legitimate access point. During training, the machine-learning model may determine variation thresholds defining an acceptable range of each of a vast number of parameters that a computing device may observe from a variety of different types of access point devices. In various embodiments, acceptable delta values of various characteristics may be expected to be close to zero.

In some embodiments, the information in the persistent profile table 210 may be based on characteristics of a variety of access points observed by the computing device. In some embodiments, the information in the persistent profile table 210 may be “bootstrapped” information obtained from a network element, such as a server. As described, the table manager 212 may update the information in the persistent profile table 210 using the observed behaviors and/or characteristics of the access point (e.g., of a legitimate access point).

In various embodiments, if the access point characterization system 200 determines that the purported access point is a legitimate access point, the table manager 212 may determine whether an entry exists for the legitimate access point's SSID, and may create an entry in the persistent profile table 210 if none exists. In some embodiments, the table manager 212 may create a new entry for the legitimate access point if a Euclidean distance between the expected access point characteristics and observed access point characteristics is greater than a threshold. For example, the table manager 212 may determine whether the distance between the current observed characteristics and/or averages in the transient table 208, and the expected characteristics in the persistent profile table 210 for the relevant SSID and/or Cluster ID exceed the threshold. In response to determining that the Euclidean distance exceeds the threshold, the table manager 212 may create a new entry for the legitimate access point in the persistent profile table 210. However, in response to determining that the Euclidean distance does not exceed the threshold, the table manager 212 may update an existing entry in the persistent profile table 210 with one or more characteristics and/or behaviors from the transient table 208.

In some embodiments, the access point characterization system 200 may re-characterize an access point as suspicious after the computing device associates with the access point. In such cases, the table manager 212 may delete the entry for the re-characterized access point from the persistent profile table 210. In some embodiments, the table manager 212 may delete entries in the persistent profile table 210 when a size of the persistent profile table 210 exceeds a threshold. In some embodiments, the table manager 212 may delete entries based on a first-in-first-out policy, a number of times that the computing devices associated with the access point (e.g., the SSID or the Cluster ID) in the past, and/or a time elapsed since the last time the computing device associated with a particular access point (e.g., the SSID or the Cluster ID).

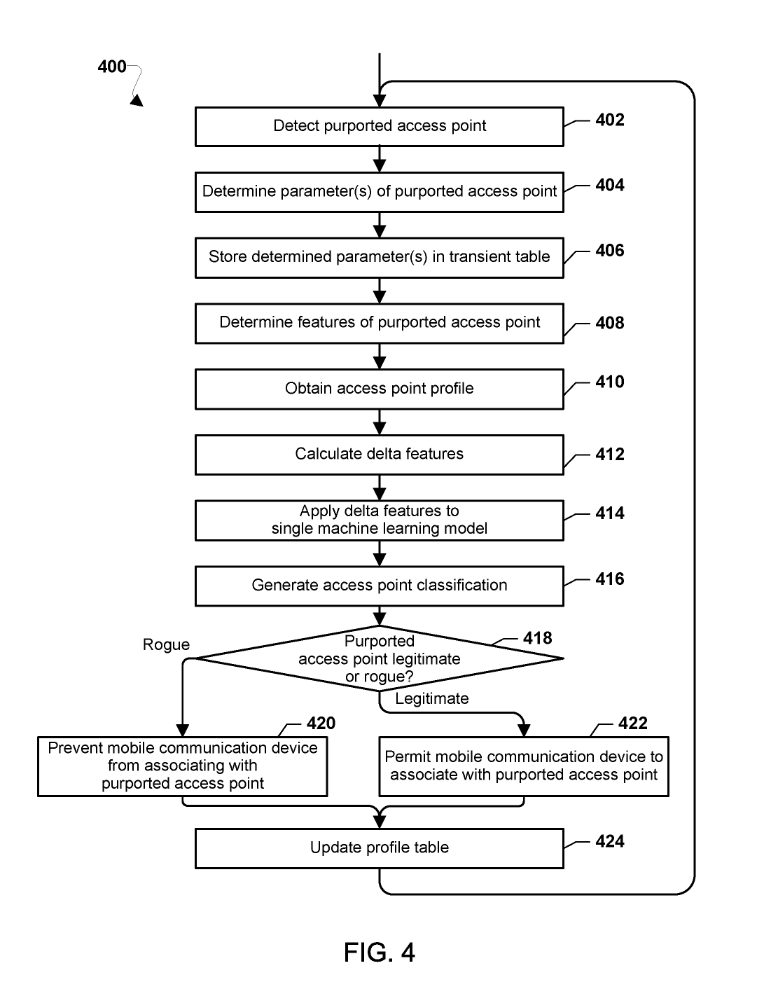

FIG. 4 illustrates a method 400 for detecting a rogue access point according to some embodiments. With reference to FIGS. 1-4, the method 400 may be implemented by one or more processors of a computing device (e.g., the mobile communication device 102).

In block 402, the processor may detect a purported access point. For example, the processor may detect that an access point advertisement message has been received by a radio frequency resource of the computing device.

In block 404, the processor may detect one or more parameters of the purported access point. The parameters of the purported access point may include one or more characteristics and/or one or more behaviors of the purported access point. For example, parameters of the purported access point may include a signal frequency, SSID, BSID, a round-trip time, local clock, remote clock, sequence number of frames, association status, beacon interval, signal strength, information elements (IEs), and/or other information. Parameters of the purported access point may include information about the communication network to which the purported access point connects. The information about the communication network may include, for example, a current network load, network configuration information, whether the network is secure or open, additional network vendor-specific parameters, and/or other information.

In block 406, the processor may store the one or more determined parameters in a transient table (e.g., the transient table 208) stored in memory of the computing device.

In block 408, the processor may determine features of the purported access point (e.g., the features 222).

In block 410, the processor may obtain an access point profile. In some embodiments, the processor may obtain the access point profile from the persistent profile table 210.

In block 412, the processor may calculate delta features (e.g., the delta features 224) based on the determined features of the purported access point and the access point profile. In some embodiments, the delta features may represent differences between the behaviors and/or characteristics of the determined features of the purported access point and behaviors and/or characteristics in the access point profile.

In block 414, the processor may apply the delta features to a machine-learning model. In some embodiments, the analyzer module 206 may apply the delta features to the machine-learning model.

In block 416, the processor may generate an access point classification of the purported access point based upon the output of the machine-learning model. For example, the analyzer module 206 may generate an access point classification 230.

In determination block 418, the processor may determine whether the purported access point is a legitimate access point or a rogue access point based upon the access point classification.

In response to determining that the purported access point is a rogue access point (i.e., determination block 418=“Rogue”), the processor may prevent the computing device from associating with the rogue access point in block 420.

In response to determining that the purported access point is a legitimate access point (i.e., determination block 418=“Legitimate”), the processor may permit the computing device to associate (e.g., connect) with the legitimate access point in block 422.

Following the operations of block 420 or block 422, the processor may update the profile table (e.g., the persistent profile table 210) in block 424.

Should the computing device detect another purported access point, the processor may repeat the operations of the method 400.

Various embodiments provide improvements in the operation of a computing device as well as the operation of a communication network. Various embodiments improve the operation of a computing device by enabling the computing device to quickly and accurately detect a rogue access point and prevent the computing device from associating with the rogue access point, thereby protecting the computing device from attack and/or compromise. Various embodiments also improve the security of a communication network by enabling communication network endpoints (such as mobile application devices) to detect rogue access points and to avoid associating with rogue access points.

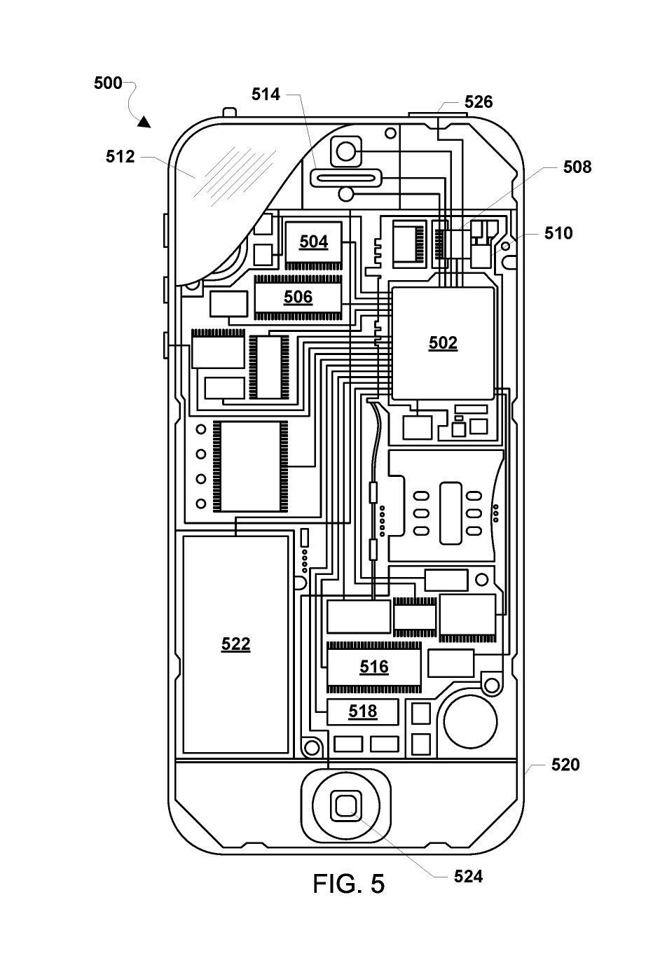

Various embodiments (including, but not limited to, the embodiments discussed with reference to FIGS. 1-4) may be implemented on a variety of computing devices, an example of which is the mobile communication device 500 illustrated in FIG. 5. The mobile computing device 500 may include a processor 502 coupled to internal memory 504, a touchscreen controller 506, a display 512, and to a speaker 514. The processor 502 may be one or more multi-core integrated circuits designated for general or specific processing tasks. The internal memory 504 may be volatile or non-volatile memory, and may also be secure and/or encrypted memory, or unsecure and/or unencrypted memory, or any combination thereof. The mobile communication device 500 may have two or more radio signal transceivers 508 (e.g., Peanut, Bluetooth, Zigbee, Wi-Fi, radio frequency (RF), etc.) and antennae 510 for sending and receiving communications, coupled to each other and to the processor 502. Additionally, the mobile communication device 500 may include an antenna 510 for sending and receiving electromagnetic radiation that may be connected to a wireless data link and/or transceiver 508 coupled to the processor 502. The mobile communication device 500 may include one or more cellular network wireless modem chip(s) 516 coupled to the processor 502 and antennae 510 that enable communications via two or more cellular networks via two or more radio access technologies.

The mobile communication device 500 may include a peripheral device connection interface 518 coupled to the processor 502. The peripheral device connection interface 518 may be singularly configured to accept one type of connection, or may be configured to accept various types of physical and communication connections, common or proprietary, such as USB, FireWire, Thunderbolt, or PCIe. The peripheral device connection interface 518 may also be coupled to a similarly configured peripheral device connection port (not shown). The mobile communication device 500 may also include speakers 514 for providing audio outputs. The mobile communication device 500 may also include a housing 520, constructed of a plastic, metal, or a combination of materials, for containing all or some of the components discussed herein. The mobile communication device 500 may include a power source 522 coupled to the processor 502, such as a disposable or rechargeable battery. The rechargeable battery may also be coupled to the peripheral device connection port to receive a charging current from a source external to the mobile communication device 500. The mobile communication device 500 may also include a physical button 524 for receiving user inputs. The mobile communication device 500 may also include a power button 526 for turning the mobile communication device 500 on and off.

The processor 502 may be any programmable microprocessor, microcomputer or multiple processor chip or chips that can be configured by software instructions (applications) to perform a variety of functions. In some computing devices, multiple processors 502 may be provided, such as one processor dedicated to wireless communication functions and one processor dedicated to running other applications. Typically, software applications may be stored in the internal memory 504 before they are accessed and loaded into the processor 502. The processor 502 may include internal memory sufficient to store the application software instructions. In various embodiments, the processor 502 may be a device processor, processing core, or a system-on-a chip.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

Various embodiments may be implemented in any number of single or multi-processor systems. Generally, processes are executed on a processor in short time slices so that it appears that multiple processes are running simultaneously on a single processor. When a process is removed from a processor at the end of a time slice, information pertaining to the current operating state of the process is stored in memory so the process may seamlessly resume its operations when it returns to execution on the processor. This operational state data may include the process's address space, stack space, virtual address space, register set image (e.g., program counter, stack pointer, instruction register, program status word, etc.), accounting information, permissions, access restrictions, and state information.

A process may spawn other processes, and the spawned process (i.e., a child process) may inherit some of the permissions and access restrictions (i.e., context) of the spawning process (i.e., the parent process). A process may be a heavy-weight process that includes multiple lightweight processes or threads, which are processes that share all or portions of their context (e.g., address space, stack, permissions and/or access restrictions, etc.) with other processes/threads. Thus, a single process may include multiple lightweight processes or threads that share, have access to, and/or operate within a single context (i.e., the processor's context).

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of detecting a rogue access point by a computing device, comprising:
determining, by a processor of the computing device, one or more features of a purported access point;
calculating, by the processor, delta features of the purported access point based on the determined one or more features and an access point profile;
applying, by the processor, the delta features to a machine-learning model; and
generating, by the processor, an access point classification based on the application of the delta features to the machine-learning model.

2. The method of claim 1, wherein determining one or more features of the purported access point comprises:
determining, by the processor, one or more parameters of the purported access point; and
determining, by the processor, the one or more features of the purported access point based on the one or more parameters of the purported access point.

3. The method of claim 1, wherein determining one or more features of the purported access point comprises:
determining, by the processor, one or more feature vectors of the purported access point.

4. The method of claim 1, wherein the calculated delta features comprise differences between the determined one or more features and the access point profile.

5. The method of claim 1, wherein the access point profile comprises expected features of the purported access point.

6. The method of claim 1, wherein the one or more features of the purported access point comprise observed characteristics of the purported access point.

7. The method of claim 1, further comprising:
determining, by the processor, whether the purported access point is a legitimate access point or a rogue access point based on the generated access point classification.

8. The method of claim 7, further comprising:
preventing the computing device from associating with the purported access point in response to determining that the purported access point is a rogue access point.

9. The method of claim 7, further comprising:
permitting the computing device to associate with the purported access point in response to determining that the purported access point is a legitimate access point.

10. A computing device, comprising:
a processor configured with processor-executable instructions to:
determine one or more features of a purported access point;
calculate delta features of the purported access point based on the determined one or more features and an access point profile;
apply the calculated delta features to a machine-learning model; and
generate an access point classification based on the application of the calculated delta features to the machine-learning model.

11. The computing device of claim 10, wherein the processor is further configured with processor-executable instructions to:
determine one or more parameters of the purported access point; and
determine the one or more features of the purported access point based on the one or more parameters of the purported access point.

12. The computing device of claim 10, wherein the processor is further configured with processor-executable instructions to:
determine one or more feature vectors of the purported access point.

13. The computing device of claim 10, wherein the processor is further configured with processor-executable instructions such that the calculated delta features comprise differences between the determined one or more features and the access point profile.

14. The computing device of claim 10, wherein the processor is further configured with processor-executable instructions such that the access point profile comprises expected features of the purported access point.

15. The computing device of claim 10, wherein the processor is further configured with processor-executable instructions such that the one or more features of the purported access point comprise observed characteristics of the purported access point.

16. The computing device of claim 10, wherein the processor is further configured with processor-executable instructions to:
determine by the processor, whether the purported access point is a legitimate access point or a rogue access point based on the generated access point classification.

17. The computing device of claim 16, wherein the processor is further configured with processor-executable instructions to:
prevent the computing device from associating with the purported access point in response to determining that the purported access point is a rogue access point.

18. The computing device of claim 16, wherein the processor is further configured with processor-executable instructions to:
permit the computing device to associate with the purported access point in response to determining that the purported access point is a legitimate access point.

19. A computing device, comprising:
means for determining one or more features of a purported access point;
means for calculating delta features of the purported access point based on the determined one or more features and an access point profile;
means for applying the calculated delta features to a machine-learning model; and
means for generating an access point classification based on the application of the calculated delta features to the machine-learning model.

20. A non-transitory processor-readable storage medium having stored thereon processor-executable instructions configured to cause a processor of a computing device to perform operations comprising:
determining one or more features of a purported access point;
calculating delta features of the purported access point based on the determined one or more features and an access point profile;
applying the calculated delta features to a machine-learning model; and
generating an access point classification based on the application of the calculated delta features to the machine-learning model.

21. The non-transitory processor-readable storage medium of claim 20, wherein the stored processor-executable instructions are configured to cause the processor of the computing device to perform operations such that determining one or more features of the purported access point comprises:
determining one or more parameters of the purported access point; and
determining the one or more features of the purported access point based on the one or more parameters of the purported access point.

22. The non-transitory processor-readable storage medium of claim 20, wherein the stored processor-executable instructions are configured to cause the processor of the computing device to perform operations such that determining one or more features of the purported access point comprises:
determining one or more feature vectors of the purported access point.

23. The non-transitory processor-readable storage medium of claim 20, wherein the stored processor-executable instructions are configured to cause the processor of the computing device to perform operations such that the calculated delta features comprise differences between the determined one or more features and the access point profile.

24. The non-transitory processor-readable storage medium of claim 20, wherein the stored processor-executable instructions are configured to cause the processor of the computing device to perform operations such that the access point profile comprises expected features of the purported access point.

25. The non-transitory processor-readable storage medium of claim 20, wherein the stored processor-executable instructions are configured to cause the processor of the computing device to perform operations such that the one or more features of the purported access point comprise observed characteristics of the purported access point.

26. The non-transitory processor-readable storage medium of claim 20, wherein the stored processor-executable instructions are configured to cause the processor of the computing device to perform operations further comprising:
determining whether the purported access point is a legitimate access point or a rogue access point based on the generated access point classification.

27. The non-transitory processor-readable storage medium of claim 26, wherein the stored processor-executable instructions are configured to cause the processor of the computing device to perform operations further comprising:
preventing the computing device from associating with the purported access point in response to determining that the purported access point is a rogue access point.

28. The non-transitory processor-readable storage medium of claim 26, wherein the stored processor-executable instructions are configured to cause the processor of the computing device to perform operations further comprising:
permitting the computing device to associate with the purported access point in response to determining that the purported access point is a legitimate access point.
